(19) United States
(12) Patent Application Publication
(10) Pub. No.: US 2022/0248698 A1
(43) Pub. Date: Aug. 11, 2022

(54) PROCESS FOR FREEZING KINDS OF FRESH COCONUT FRUITS

(71) Applicant: Shadid Naim, Sanyo Domingo Comity (DM)

(72) Inventor: Shadid Naim, Sanyo Domingo Comity (DM)

(21) Appl. No.: 17/585,937

(22) Filed: Jan. 27, 2022

(30) Foreign Application Priority Data
Feb. 8, 2021 (VN) 1-2021-00723

(51) Int. Cl. A23B 7/04; A23L 19/00; B65B 53/00; B65B 25/02

(52) U.S. Cl. CPC A23B 7/0441; A23L 19/03; A23V 2002/00; B65B 25/02; B65B 53/00

(57) ABSTRACT

Provided is a process for freezing kinds of fresh coconut fruits including the following steps: i) selecting coconut fruits; ii) cleaning the coconut fruits; iii) drying the surface of the husked coconut fruits; iv) freezing the husked coconut fruits; and v) packing the husked coconut fruits, wherein step iv) is performed according to seven phases until the temperature of the husked coconut fruits of −18° C. is obtained.

### CROSS-REFERENCE TO RELATED APPLICATIONS

This application claims priority to Vietnamese application No. 1-2021-00723, having a filing date of Feb. 8, 2021, the entire contents of which are hereby incorporated by reference.

### FIELD OF TECHNOLOGY

The following relates to the post-harvest processing of agricultural products. In particular, the following relates to a process for freezing kinds of fresh coconut fruits without use of any chemicals without use of any chemicals or preservatives, but the coconut fruits may be stored up to 24 months, with the quality of coconut fruits is ensured the same as the freshly harvested coconut fruits.

### BACKGROUND

Coconut is a popular fruit tree grown throughout tropical areas such as Rajasthan, Maharashtra, India, Philippines etc. In these regions, coconut trees are ubiquitous from the coast to the desert and brings a plurality of benefits to local residents. Especially, in the Philippines, the coconut tree is commonly called the “tree of life”.

Vietnam is also in the tropical climate zone and has a long coastline, therefore the coconut tree is distributed from Northern to Southern, especially in the western provinces of Vietnam such as Can Tho. Especially, Ben Tre province has the largest coconut growing area in the Vietnam and is known as the “coconut land”. The coconut tree has been become a cultural icon in the Ben Tre because it brings a plurality of benefits to the people.

Utility of the different parts of coconut fruits comprises:

White copra is edible and used in the fresh or dried form in some dishes. Dried copra is a material for production of coconut oil.

Coconut juice contain substances, such as sugars, proteins, antioxidants, vitamins and minerals, which supplies and creates a good isotonic electrolyte balance as well as which is a nutritious food source. Coconut juice is used as a beverage in the tropical regions. Coconut juice may be used as an infusion solution. Coconut juice is also used for production of nata de coco dessert.

Coconut cream, which is also known as the coconut milk (contains about 17% of fat) is prepared from the shredded copra, which is mixed with hot water or hot milk. Coconut cream is a main ingredient of dishes in the Southeast Asia region and Vietnam. Copra residues from production of coconut milk are used as an animal feed.

Coconut candy is a popular sweet in the Vietnam, its main ingredient is concentrated coconut cream mixed with Pineapple, Durian or Chocolate flavors.

Coconut jam is prepared from shredded copra and impregnated with sugar, and then dried and used during holidays of Vietnam.

Endocarp of coconut fruits are used as water ladle and materials for making handicrafts.

Coirs of coconut fruits are used as beckets, ropes, carpets, brushes, boat mosaic as well as compaction materials; it is also widely used in the horticulture as a filler in fertilizers.

Exocarps and coirs of coconut fruits can be used as fuel sources or for production of charcoal, active coal because they are very rich in carbon.

Especially, it is known that coconut fruits provide a source of natural mineral water which is extremely good for health.

Five health benefits of the coconut fruits are indicated below:

i) Providing Water, Reducing the Risk of Dehydration

Coconut juice is known as the natural mineral water, which is a great drink in the days of summer. Coconut juice contains a lot of natural minerals, especially potassium, which has the effect of regulating internal fluid and replenishing water for the body, and especially coconut juice is very good for the kidneys, and it cleans the urinary tract, and prevents nephrolithiasis.

ii) Providing the Energy, Enhancing the Immune System

Coconut juice contains a plurality of essential minerals, such as iron, potassium, calcium, magnesium, phosphorus, sodium, lauric acid, a low amount of fat, but a high amount of vitamins therefore, it helps to balance the health of the muscle, the cardiovascular, the nervous system and the immune system. Furthermore, coconut juice contains a relative low amount of sugar compared to other bottled water, it helps to optimally replenish and enhance the energy for the body.

iii) Anti-Bacterial, Anti-Inflammatory, Good for the Cardiovascular

Coconut juice contains following components: monolaurin, anti-virus, anti-bacterial and antiprozoal monoglyceride, which has the extremely good anti-bacterial, anti-inflammatory, antioxidant effects. It also aids in the treatment and balance of blood pressure due to high amounts of potassium and lauric acid. Furthermore, it also helps to increase HDL (good) cholesterol in order to maintain the cardiovascular health.

iv) Good for the Digestive System

Coconut juice contains a high amount of lauric acid, when introducing into the body, it will be converted to monolaurin-a substance has an anti-virus, anti-bacterial effect and prevents intestinal diseases, parasites and infection in the gastrointestinal tract. Coconut juice is very beneficial for the intestinal tract and the stomach, and it can treat dysentery, constipation, indigestion, worms in the intestinal tract, cholera, etc.

v) Beautifying Skin, and Reducing Weight

It is known that coconut juice is one of the skin-beautifying panaceas. Coconut juice provides adequate water for the body, helps to keep adequate moisture for skin, and avoids dry skin. Moreover, laurin acid in coconut juice also has the effects of preventing skin aging, balancing pH and keeping balance, linking skin tissues, keeping skin healthy. Furthermore, this is a very good drink for people with obesity, because coconut juice is a natural electrolyte, which helps to reduce the thirst and enhances the metabolism of the body.

With such good effects for the health, the need to preserve the whole coconut fruits with the assurance of quality for as long as possible and to distribute the whole coconut fruits to all consumers including the export is very urgent. This also facilitates the economic development of people in the coconut growing regions.

The coconut fruits themself that having whole shell can be maintained for 2 to 3 weeks. Due to the high harvesting yield, it is still not enough time to completely consume harvested coconut quantities although only harvesting one crop each year. Therefore, there is a need for preservation measures to extend the circulation and distribution time of coconut fruits.

Some solutions for preserving fresh coconut fruits are known, typically the method for injecting preservatives directly into coconut fruits. However, the disadvantage of this solution is that it changes the quality of coconut fruits (the presence of chemicals in coconut juice), so it is difficult to be accepted by consumers.

Recently, the Research Institute for Oil and Oil Plants, Vietnam investigated and found that sodium metabisulfite-a chemical that is allowed to use in the food processing-can be used for treating the outer surface of endocarp of coconut fruits (the exocarps of coconut fruits were peeled off). The research shows that with an appropriate dose of use and an appropriate treating time, sodium metabisulfite exists only in the outside of exocarps of coconut fruits, which has a whitening effect and an ability to kill microorganisms in the outside of endocarp of coconut fruits. Because this chemical does not permeate into the contents of coconut fruits, the substance of copra and coconut juice can be kept. After the surface of coconut fruits was treated by sodium metabisulfite, the coconut fruits will be wrapped by a film (which is specifically used to preserve fruits) and stored at about 5° C. With this treatment, the freshness of coconut fruits will be kept (the outside color of coconut fruits is still white, and not browned) for 4-6 weeks.

Another typical solution is a method for flash freezing coconut fruits, wherein coconut fruits are quickly frozen to a temperature in a range from −35° C. to −40° C., and then stored at −18° C. This solution meets the requirements for storage of fresh coconut fruits for exporting. However, the disadvantage of this solution is that it is a high cost, and the coconut fruits are no longer fresh but already-frozen products. In addition, due to the suddenly deep freezing, cellular tissue structures of coconut fruits are broken, the quality of coconut fruits, such as taste, color, nutritional ingredients, is reduced. The frozen coconut juice within the endocarp of coconut fruits is expanded, which results in the endocarp of coconut fruits is sometimes broken, and the quality is not ensured. The shelf life of coconut fruits treated by this method is not long, only 8 to 12 weeks, i.e., 2 to 3 months, with the significantly reduced quality.

In order to overcome the crack of the endocarp of the coconut fruits, Vietnamese Patent No. VN1-0000056 of the inventors Tran Duc Ba and Nguyen Van Khang provides a solution wherein coconut juice in the coconut fruits is sucked out with an amount about 10-15% volume, and then quickly frozen at a temperature in a range from −35° C. to −40° C., and then stored at −18° C. By this solution, the fresh coconut fruits can be stored up to 6 months.

WO2018/164689A1 of Torin KLINE et al relates to a system and method for preparing frozen coconut fruits comprising drying dehusked coconut, partially freezing the dried dehusked coconut, vacuum sealing and flash freezing in a flash freezing unit, which has a temperature in a range from −65° C. to −72° C. This system and method can store the fresh coconut fruits over 1 year. However, in order to achieve such deep-freezing temperature, the costly freezing systems are required.

However, in order to deliver the fresh coconut fruits to the consumers all around the world, the shelf life, which is achieved by the above solutions, is still not enough. The increase of shelf life of the fresh coconut fruits will facilitate the enhancement of the economic value of coconut fruits, which are agricultural products available in the Vietnam.

### SUMMARY

An aspect relates to a process for freezing kinds of fresh coconut fruits without use of any chemicals without use of any chemicals or preservatives, wherein the coconut fruits can be stored up to 24 months with the same quality as the freshly harvested coconut fruits.

Accordingly, the inventor conducted a plurality of experiments for freezing the fresh coconut fruits with the different time periods and found the suitable descending temperature ranges and the respective time periods for storage of the coconut fruits, thereby it does not only make the coconut fruits are not broken, and coconut juice is not leaked as when they are rapidly frozen but also keep the freshness, coconut juice is more sweet and more fragrant. Especially, the shelf life of the coconut fruits is extended to 24 months without use of any chemicals or preservatives. This is an unexpected result compared to the known solutions.

This is because in the process for freezing as described above, the water molecules in the coconut fruits are frozen, but the cell tissue structures are not disrupted, the oxidation is inhibited, the bacterial infection is prevented. Thereby, taste and color of the coconut fruits is unchanged as well as the content of nutrients are maintained up to 99.7%.

In particular, the process for freezing kinds of fresh coconut fruits according to embodiments of the present invention comprises the following steps:

i) Selecting Coconut Fruits

Selecting the coconut trees of 15 years old or the Siamese blue coconut trees, which fruit is about 8 months. In an embodiment, the coconut fruits are harvested when they are 33-35 day old because of this age, the sweetness of coconut juice satisfies the required standards, i.e., the sweetness of coconut juice is 75° Brix or more. This is the different feature compared to the known solutions, wherein the coconut fruits are usually harvested when they are only 20-25 day old.

ii) Cleaning the Coconut Fruits

After harvesting, cutting the coconut fruits and removing outermost blue exocarps, and then peeling off coirs of the coconut fruits until endocarps of the coconut fruits are explored. This step is performed by hands or a machine for peeling off exocarps of the coconut fruits as long as the natural shape of the coconut fruits is maintained, and the outer skins are not weakened or the endocarps of the coconut fruits are not damaged. In an embodiment, the removal of the exocarp is completely performed by hands.

Next, washing and cleaning 3 eyes of the husked coconut fruits, until the openings of the husked coconut fruits are explored, but the openings of the husked coconut fruits are not broken.

Rapidly washing the husked coconut fruits by water, picking up them immediately, and then draining, and not impregnating with water for a long time.

iii) Drying the Surface of the Husked Coconut Fruits

After washing with water, drying the surface of the husked coconut fruits according to a way, which is similar to the nature way, i.e., placing the husked coconut fruits on the drying inox shelves in the room, and then using industrial fans for blowing from a plurality of directions of the drying shelves for drying until the of surface of endocarps of the husked coconut fruits is changed to peach brown là [symbol] u′ [symbol] c.

Measuring moisture content on the surface of endocarps of the husked coconut fruits so that it does not exceed 5-10%.

iv) Freezing the Husked Coconut Fruits

This is the most important step of the process for freezing kinds of fresh coconut fruits according to embodiments of the present invention.

After drying, the husked coconut fruits are transferred into a freezing room for freezing. The freezing room for freezing the husked coconut fruits is a type of room that can freeze the temperature to −18° C. or less and has a system for adjusting temperature and time. The husked coconut fruits are transferred into the freezing room, neatly arranged on the shelves, and then the step of freezing is performed according to 7 following phases:

Freezing phase 1: reducing temperature of the husked coconut fruits to a temperature in a range from +5° C. to 0° C. and maintaining this temperature for 66-78 hours, or about 72 hours, i.e., 3 days.

Freezing phase 2: further reducing temperature of the husked coconut fruits to a temperature in a range from 0° C. to −5° C. and maintaining this temperature for 66-78 hours, or about 72 hours, i.e., 3 days.

Freezing phase 3: further reducing temperature of the husked coconut fruits to a temperature in a range from −5° C. to −10° C. and maintaining this temperature for 66-78 hours, or about 72 hours, i.e., 3 days.

Freezing phase 4: further reducing temperature of the husked coconut fruits to a temperature in a range from −10° C. to −12° C. and maintaining this temperature for 30-42 hours, or about 36 hours, i.e., 1.5 days.

Freezing phase 5: further reducing temperature of the husked coconut fruits to a temperature in a range from −12° C. to −14° C. and maintaining this temperature for 30-42 hours, or about 36 hours, i.e., 1.5 days.

Freezing phase 6: further reducing temperature of the husked coconut fruits to a temperature in a range from −14° C. to −16° C. and maintaining this temperature for 30-42 hours, or about 36 hours, i.e., 1.5 days.

Freezing phase 7: further reducing temperature of the husked coconut fruits to a temperature in a range from −16° C. to −18° C. and maintaining this temperature for 42-54 hours, or about 48 hours, i.e., 2 days.

Therefore, total time for freezing the husked coconut fruits in a range from 330 hours to 414 hours, or about 372 hours, i.e., 15.5 days.

v) Packing the Husked Coconut Fruits

After freezing, classifying the husked coconut fruits, which have the temperature in a range from −16° C. to −18° C. according to their size and weight, and then packing them into carton boxes. Next, wrapping the carton boxes by a shrink film using the system for cutting and gluing a shrink film, and then returning them into the freezing room in order to maintain their temperature at −18° C. This temperature will be maintained until use.

### DETAILED DESCRIPTION

Hereinafter, in order to describe embodiments of the present invention more specifically, an exemplary embodiment of the present invention will be described in more details. However, it should be understood that these embodiments are only intended to illustrate embodiments of the present invention and are not intended to limit the scope of the present invention. Any other embodiments that can be inferred from these embodiments by one of ordinary skill in the art are within the scope of embodiments of the present invention. In particular, the process for freezing kinds of fresh coconut fruits according to embodiments of the present invention comprises the following steps:

i) Selecting Coconut Fruits

Selecting the coconut trees of 15 years old or or the Siamese blue coconut trees, which the fruit is about 8 months. In an embodiment, the coconut fruits are harvested when they are 33-35 day old because at this age, the sweetness of coconut juice satisfies the required standards, i.e., the sweetness of coconut juice is 75° Brix or more.

ii) Cleaning the Coconut Fruits

After harvesting, cutting the coconut fruits and removing outermost blue exocarps, and then peeling off coirs of the coconut fruits until endocarps of the coconut fruits are explored. This step is performed by hands or a machine for peeling off exocarps of the coconut fruits as long as the natural shape of the coconut fruits is maintained, and the outer skins are not weakened or the endocarps of the coconut fruits are not damaged. In an embodiment, the removal of the exocarp is completely performed by hands.

Next, washing and cleaning 3 eyes of the husked coconut fruits, until the openings of the husked coconut fruits are explored, but the openings of the husked coconut fruits are not broken.

Rapidly washing the husked coconut fruits by water, picking up them immediately, and then draining, and not impregnating with water for a long time.

iii) Drying the Surface of the Husked Coconut Fruits

After removing the exocarps and washing, placing the husked coconut fruits on inox shelves in the room, and then using industrial fans for blowing from a plurality of directions of the drying shelves for drying until the of surface of endocarps of the husked coconut fruits is changed to peach brown.

Measuring moisture content on the surface of endocarps of the husked coconut fruits so that it does not exceed 5-10%.

iv) Freezing the Husked Coconut Fruits

After drying, the husked coconut fruits are transferred into a freezing room for freezing. The freezing room for freezing the husked coconut fruits is a type of room that can freeze the temperature to −18° C. or less and has a system for adjusting temperature and time. The husked coconut fruits are transferred into the freezing room, neatly arranged on the shelves, and then the step of freezing is performed according to 7 following phases:

Freezing phase 1: reducing temperature of the husked coconut fruits to a temperature in a range from +5° C. to 0° C. and maintaining this temperature for 66-78 hours, or about 72 hours, i.e., 3 days.

Freezing phase 2: further reducing temperature of the husked coconut fruits to a temperature in a range from 0° C. to −5° C. and maintaining this temperature for 66-78 hours, or about 72 hours, i.e., 3 days.

Freezing phase 3: further reducing temperature of the husked coconut fruits to a temperature in a range from −5° C. to −10° C. and maintaining this temperature for 66-78 hours, or about 72 hours, i.e., 3 days.

Freezing phase 4: further reducing temperature of the husked coconut fruits to a temperature in a range from −10° C. to −12° C. and maintaining this temperature for 30-42 hours, or about 36 hours, i.e., 1.5 days.

Freezing phase 5: further reducing temperature of the husked coconut fruits to a temperature in a range from −12° C. to −14° C. and maintaining this temperature for 30-42 hours, or about 36 hours, i.e., 1.5 days.

Freezing phase 6: further reducing temperature of the husked coconut fruits to a temperature in a range from −14° C. to −16° C. and maintaining this temperature for 30-42 hours, or about 36 hours, i.e., 1.5 days.

Freezing phase 7: further reducing temperature of the husked coconut fruits to a temperature in a range from −16° C. to −18° C. and maintaining this temperature for 42-54 hours, or about 48 hours, i.e., 2 days.

Therefore, total time for freezing the husked coconut fruits in a range from 330 hours to 414 hours, or about 372 hours, i.e., 15.5 days.

v) Packing the Husked Coconut Fruits

After freezing, classifying the husked coconut fruits, which have the temperature in a range from −16° C. to −18° C. according to their size and weight, and then packing them into carton boxes. Next, wrapping the carton boxes by a shrink film by the system for cutting and gluing a shrink film, and then returning them into the freezing room in order to maintain their temperature at −18° C. This temperature will be maintained until use.

By the process for freezing kinds of fresh coconut fruits according to embodiments of the present invention, the freshness and the deliciousness of the fresh coconut fruits are kept in the extended period of time up to 24 months, which are completely achieved by the freezing method, without use of any chemicals, therefore the process is very safe for users and environmental-friendly.

The freshness of the fresh coconut fruits frozen according to the process according to embodiments of the present invention is kept, which is similar to that of freshly-harvested coconut fruits (the process according to embodiments of the present invention is similar to the methods of preserving living cells). This process for freezing is to freeze the water molecules in the coconut fruits, the coconut meat, thereby the cell tissue structures are not disrupted, the oxidation is inhibited, the bacterial infection is prevented, thereby the taste and the color of these frozen coconut fruits are unchanged as well as the content of nutrients are maintained up to 99.7%.

Another advantage of the process for freezing kinds of fresh coconut fruits according to embodiments of the present invention is that the sweetness of coconut juice and the coconut copra is increased and especially the taste of the fresh coconut fruits is more fragrant.

By the process according to embodiments of the present invention, the coconut fruits may be stored for a long time, which facilitates the export of coconut fruits to other countries, brings the great economic benefits to the coconut growers and the coconut exporting and processing enterprises.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A process for freezing kinds of fresh coconut fruits comprising:
i) selecting coconut fruits;
selecting coconut fruits from coconut trees of 15 years old or more;
ii) cleaning the coconut fruits;
cutting and removing exocarps of the coconut fruits, peeling off coirs of the coconut fruits until endocarps of the coconut fruits are explored;
washing and cleaning 3 eyes of the husked coconut fruits;
cleaning until the openings of the husked coconut fruits are explored, but the openings of the husked coconut fruits are not broken;
rapidly washing the husked coconut fruits by water, picking up them immediately, and then draining, and not impregnating with water for a long time;
iii) drying the surface of the husked coconut fruits;
placing the husked coconut fruits on inox shelves in the room, and then using industrial fans for drying from a plurality of directions of the drying shelves until the surface of endocarps of the husked coconut fruits is changed to peach brown;
measuring moisture content on the surface of endocarps of the husked coconut fruits so that it does not exceed 5-10%;
iv) freezing the husked coconut fruits according to 7 following phases:
freezing phase 1: reducing temperature of the husked coconut fruits to a temperature in a range from +5° C. to 0° C. and maintaining this temperature for 66-78 hours;
freezing phase 2: further reducing temperature of the husked coconut fruits to a temperature in a range from 0° C. to −5° C. and maintaining this temperature for 66-78 hours;
freezing phase 3: further reducing temperature of the husked coconut fruits to a temperature in a range from −5° C. to −10° C. and maintaining this temperature for 66-78 hours;
freezing phase 4: further reducing temperature of the husked coconut fruits to a temperature in a range from −10° C. to −12° C. and maintaining this temperature for 30-42 hours;
freezing phase 5: further reducing temperature of the husked coconut fruits to a temperature in a range from −12° C. to −14° C. and maintaining this temperature for 30-42 hours;
freezing phase 6: further reducing temperature of the husked coconut fruits to a temperature in a range from −14° C. to −16° C. and maintaining this temperature for 30-42 hours; and
freezing phase 7: further reducing temperature of the husked coconut fruits to a temperature in a range from −16° C. to −18° C. and maintaining this temperature for 42-54 hours; and
v) packing the husked coconut fruits
classifying the husked coconut fruits according to their size and weight, and then packing them into carton boxes;
using a shrink film to wrap the carton boxes by the system for cutting and gluing a shrink film;
maintaining the husked coconut fruits in the carton boxes at a temperature about −18° C. until use.

2. The process for freezing kinds of fresh coconut fruits according to claim 1, wherein step iv) is performed as follows:
freezing phase 1: reducing temperature of the husked coconut fruits to a temperature in a range from +5° C. to 0° C. and maintaining this temperature for 72 hours;
freezing phase 2: further reducing temperature of the husked coconut fruits to a temperature in a range from 0° C. to −5° C. and maintaining this temperature for 72 hours;
freezing phase 3: further reducing temperature of the husked coconut fruits to a temperature in a range from −5° C. to −10° C. and maintaining this temperature for 72 hours;
freezing phase 4: further reducing temperature of the husked coconut fruits to a temperature in a range from −10° C. to −12° C. and maintaining this temperature for 36 hours;
freezing phase 5: further reducing temperature of the husked coconut fruits to a temperature in a range from −12° C. to −14° C. and maintaining this temperature for 36 hours;
freezing phase 6: further reducing temperature of the husked coconut fruits to a temperature in a range from −14° C. to −16° C. and maintaining this temperature for 36 hours; and
freezing phase 7: further reducing temperature of the husked coconut fruits to a temperature in a range from −16° C. to −18° C. and maintaining this temperature for 48 hours.
